(19) United States
(12) Patent Application Publication
(10) Pub. No.: US 2007/0008403 A1
(43) Pub. Date: Jan. 11, 2007

(54) Storage apparatus for digital/analog TV VIDEO/AUDIO media

(76) Inventors: Wen-Ming Huang, Dasi Township (TW); Hsin-Ching Yin, Gangshan Township (TW); Chi-Wei Hsiao, Jhonghe City (TW); Ching-Chun Huang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/483,632

(22) Filed: Jul. 11, 2006

(30) Foreign Application Priority Data
Jul. 11, 2005 (TW) 094211770

(51) Int. Cl. H04N 7/14

(52) U.S. Cl. 348/14.04

(57) ABSTRACT

A storage apparatus for DTV/ATV/DAB/ANALOG AUDIO BROADCASTING media is provided, including a USB hub, at least a DTV/ATV/DAB/ANALOG AUDIO BROADCASTING interface converter, and a plurality of storage media interfaces. The upstream port of the USB hub is connected to a USB interface of an electronic device. The DTV/ATV/DAB/ANALOG AUDIO BROADCASTING interface converter and a plurality of storage media interfaces are connected respectively to the downstream ports of the USB hub. The DTV/ATV/DAB/ANALOG AUDIO BROADCASTING interface converter can convert DTV/ATV/DAB/ANALOG AUDIO BROADCASTING signals into data uploaded through the USB hub to the electronic device with the USB interface for playing. The electronic device can process the data, such as compression, filtering, and so on, and then downloads the processed data to each storage media interface, such as flash memory, CD-RW, DVD-RW, and hard disk, through the USB hub.

### BACKGROUND OF THE INVENTION

1. Field of the Invention

The present invention relates to a storage apparatus for digital/analog TV video/audio media and, more particularly, to a portable storage apparatus for storing digital/analog TV video and broadcasting audio.

2. The Related Arts

The analog/digital TV (ATV/DTV) and analog /digital audio broadcasting (ANALOG AUDIO BROADCASTING /DAB) create a new era for home audiovisual entertainment. Especially, as the DTV and DAB become popular among households, more channels are available for information and entertainment transmission to improve the life quality. However, the conventional DTV and DAB tend to provide one-way broadcasting in application, such as using digital set-top box to connect to high definition TV (HDTV) or digital stereo systems for high resolution audiovisual. There is a general lack of integrating multimedia applications, such as the on-the-fly recording of DTV and DAB programs, or editing of stored DTV and DAB contents. This restricts the impact and the functions of DTV and DAB.

Several solutions have been proposed in various patents. For example, Taiwan Patent No. 515,200 discloses a method and device for the set-top box for internal media format conversion and program downloading. The program interface has a complicated structure, which is expensive to build and difficult to use. Furthermore, the disclosed device does not provide on-the-fly recording while the user viewing the DTV or DAB program, which is a major disadvantage for DTV/DAB popularity.

U.S. Pat. No. 2004/0,264,929, “Information Storage Medium Storing Information for Generating DTV Stream, and Method and Apparatus for Converting DTV Stream”, discloses a method to convert DVD audiovisual media format, such as MPEG-2 TS, MPEG-4, and MPEG-7, to DTV stream of DTV format for DTV broadcasting. The conversion method and structure are only for one-way data format conversion to provide DTV broadcasting. No functions are provided for DTV/DAB data conversion storage. Therefore, the disclosed method provides only a new source for DTV broadcasting, and little to the two-way application of DTV.

### SUMMARY OF THE INVENTION

The present invention has been made to overcome the aforementioned drawbacks of the conventional technologies. The primary objective of the present invention is to provide a storage apparatus for storing digital/analog TV video (DTV/ATV) and digital/analog audio broadcasting (DAB/ANALOG AUDIO BROADCASTING ) with at least a digital/analog TV video/audio interface converter for converting ATV/DTV or ANALOG AUDIO BROADCASTING/DAB to an electronic device, such as notebook PC, tablet PC, XBOX, XBOX360, PS, PS2, PS3, PSP, PDA, and so on, with a USB interface for playing and provides to other portable storage media storage for storing.

Another objective of the present invention is to provide a storage apparatus for storing DTV/ATV/DAB/ANALOG AUDIO BROADCASTING with at least USB hub with a plurality of storage media interfaces. The data can be transmitted from the electronic device with a USB interface to a plurality of storage media interfaces through the USB hub. The storage media interfaces are connected to portable storage devices, such as flash memory sticks, card reader, CD-RW, DVD-RW or hard disk. The DTV/ATV, ANALOG AUDIO BROADCASTING, DAB can then be stored in these portable storage media.

To achieve the aforementioned objectives, the present invention provides a storage apparatus for DTV/ATV/DAB/ANALOG AUDIO BROADCASTING media, comprising at least a USB hub, a DTV/ATV/DAB/ANALOG AUDIO BROADCASTING interface converter, and a plurality of storage media interface, wherein the upstream port of the USB hub is connected to a USB interface of an electronic device. The DTV/ATV/DAB/ANALOG AUDIO BROADCASTING interface converter and a plurality of storage media interfaces are connected respectively to the downstream ports of the USB hub. The DTV/ATV/DAB/ANALOG AUDIO BROADCASTING interface converter can convert DTV/ATV/DAB/ANALOG AUDIO BROADCASTING signals into data uploaded through the USB hub to the electronic device with the USB interface for playing. The electronic device can process the data, and then downloads the processed data to each storage media interface through the USB hub. The storage media interfaces are connected respectively to portable storage devices, such as flash memory, CD-RW, DVD-RW and hard disk, so that the DTV/ATV/DAB/ANALOG AUDIO BROADCASTING data can be stored in the portable storage media. The present invention forms a portable, two-way and multi-path recording storage media apparatus for DTV/ATV/DAB/ANALOG AUDIO BROADCASTING data.

The advantage of the present invention is to enable the playing, storing, and on-the-fly recording of the DTV/ATV/DAB/ANALOG AUDIO BROADCASTING data through a simple and inexpensive structure and method. With the present invention, the DTV/ATV/DAB/ANALOG AUDIO BROADCASTING data can be played as well as stored in portable storage devices, such as flash memory, CD-RW, DVD-RW and hard disk for various further applications.

These and other objects, features and advantages of the invention will be apparent to those skilled in the art, from a reading of the following brief description of the drawings, the detailed description of the preferred embodiments, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a system block diagram of the present invention;

FIG. 2 is a flowchart of the present invention;

FIG. 3 is the second embodiment of the present invention; and

FIG. 4 is the third embodiment of the present invention.

### DETAILED DESCRIPTION OF THE PREFERRED EMBODIMENTS

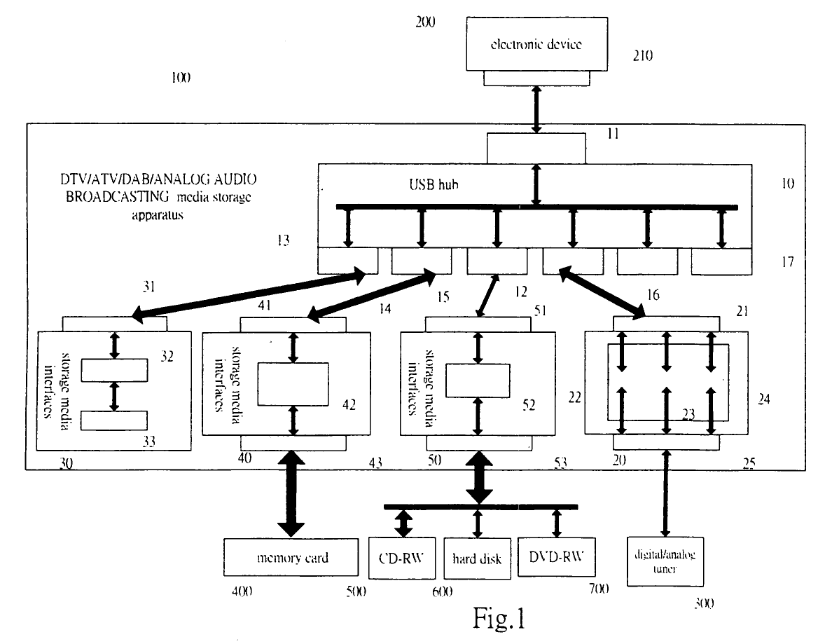

With reference to the drawings and in particular to FIG. 1, which shows a DTV/ATV/DAB/ANALOG AUDIO BROADCASTING media storage apparatus, generally designated with reference numeral 100, constructed in accordance with a first embodiment of the of the present invention, the DTV/ATV/DAB/ANALOG AUDIO BROADCASTING media storage apparatus 100 comprises at least a USB hub 10, a DTV/ATV/DAB/ANALOG AUDIO BROADCASTING interface converter 20, and a plurality of storage media interfaces 30,40, 50. The USB hub 10 is connected to an upstream port 11 and a plurality of downstream ports 12, 13, 14, 15, 16, 17. The upstream port 11 is connected to a USB interface 210 of an electronic device 200 for two-way data communication between the downstream ports 12-17 and the electronic device 200. The electronic device 200 is not restricted to any specific type, including PC, notebook PC, PDA, tablet PC, or game machines with USB interface.

The aforementioned DTV/ATV/DAB/ANALOG AUDIO BROADCASTING interface converter 20 comprises a USB controller 21, a DTV signal processor 22, a DAB signal processor 23, an ATV signal processor 24, and a signal input interface 25. The USB controller 21 is connected to the downstream port 12 of the USB hub 10 to form a USB-type two-way data communication between the DTV/ATV/DAB/ANALOG AUDIO BROADCASTING interface converter 20 and the USB hub 10. The DTV signal processor 22 provides the conversion of a DTV signal into a format suitable for playing on the electronic device 200. The DTV signal processor 22 is connected to the USB controller 21, which is connected to the USB hub 10. The upstream port 11 of the USB hub 10 transmits the processed DTV data to the electronic device 200 for playing or storage.

The DAB signal processor 23 provides the conversion of DAB signal into a format suitable for playing on the electronic device 200. The DAB signal processor 23 is connected to the USB controller 21, which is connected to the USB hub 10. The upstream port 11 of the USB hub 10 transmits the processed DAB data to the electronic device 200 for playing or storage.

The ATV signal processor 24 provides the conversion of ATV signal into a format suitable for playing on the electronic device 200. The ATV signal processor 24 is connected to the USB controller 21, which is connected to the USB hub 10. The upstream port 11 of the USB hub 10 transmits the processed ATV data to the electronic device 200 for playing or storage.

The signal input interface 25 is externally connected to a digital/analog tuner 300. The digital/analog tuner 300 is for receiving DTV/ATV/DAB/ANALOG AUDIO BROADCASTING signals. The signal input interface 25 is to multiplex the DTV/ATV/DAB/ANALOG AUDIO BROADCASTING signals. The signal input interface 25 is connected internally to the DTV signal processor 22, the DAB signal processor 23, and the ATV signal processor 24 in order to transmit the DTV/ATV/DAB/ANALOG AUDIO BROADCASTING signals to the DTV signal processor 22, the DAB signal processor 23, and the ATV signal processor 24 for conversion processing.

The storage media interfaces 30, 40, 50 are not limited to any specific type. In the present invention, the portable storage media interfaces, such as flash memory sticks, card reader, and ATA/ATAPI CD-RW and hard disk, are used as embodiment. Other equivalent portable storage media interfaces are also within the scope of the present invention. The storage media interface 30 comprises a USB controller 31, a flash memory access controller 32, and at least a flash memory 33. The USB controller 31 is connected to a downstream port 13 of the USB hub 10 to form a two-way USB-type data connection between the storage media interface 30 and the USB hub 10. The flash memory access controller 32 is to control the data access, and the flash memory 33 is connected to and controlled by the flash memory access controller 32. The flash memory access controller 32 is connected to the USB controller 31 to transmit, through the USB hub 10, digital data converted by the DTV/ATV/DAB/ANALOG AUDIO BROADCASTING interface converter 20 to the electronic device 200 for playing or storage; or alternatively, data processed, such as compression, filtering, and format conversion, by the electronic device 200 can be downloaded for storing in the flash memory 33. In this way, object of storing the DTV/DAB data in the portable flash memory storage media is achieved.

The storage media interface 40 comprises a USB controller 41, a card reader controller 42, and a memory connector 43. The USB controller 41 is connected to a downstream port 14 of the USB hub 10 to form a two-way USB-type data connection between the storage media interface 40 and the USB hub 10. The card reader controller 42 is to control the data access, and the memory connector 43 is to provide external connection to at least a memory card 400. The memory card 400 can be the CF/SD/MMC/XD/SM/MS/MSPRO/MS DUO, and so on, type of flash memory card. The memory connector 43 is connected to the card reader controller 42 so that the memory card 400 is controlled by the card reader controller 42. The card reader controller 42 is connected to the USB controller 41 to transmit, through the USB hub 10, digital data converted by the DTV/ATV/DAB/ANALOG AUDIO BROADCASTING interface converter 20 to the electronic device 200 for playing or storage; or alternatively, data processed, such as compression, filtering, and format conversion, by the electronic device 200 can be downloaded for storing in the memory card 400. In this way, object of storing the DTV/DAB data in the portable card reader storage media is achieved.

The storage media interface 50 comprises a USB controller 51, an ATA/ATAPI interface controller 52, and a plurality of interface connectors 53, 54, 55. The USB controller 51 is connected to a downstream port 15 of the USB hub 10 to form a two-way USB-type data connection between the storage media interface 50 and the USB hub 10. The ATA/ATAPI controller 52 is to control the data access, and the interface connectors 53, 54, 55 are to provide external connection to a CD-RW 500, a hard disk 600, and a DVD-RW 700, respectively. The CD-RW 500, the hard disk 600, and the DVD-RW 700 have an ATA/ATAPI type interface. The interface connectors 53, 54, 55 are connected to the ATA/ATAPI controller 52 so that the CD-RW 500, the hard disk 600, and the DVD-RW 700 are controlled by the ATA/ATAPI controller 52. The ATA/ATAPI controller 52 is connected to the USB controller 51 to transmit, through the USB hub 10, digital data converted by the DTV/ATV/Dab/ANALOG AUDIO BROADCASTING interface converter 20 to the electronic device 200 for playing or storage; or alternatively, data processed, such as compression, filtering, and format conversion, by the electronic device 200 can be downloaded for storing in the CD-RW 500, the hard disk 600, and the DVD-RW 700. In this way, object of storing the DTV/DAB data in the portable D-RW, hard disk, and DVD-RW storage media is achieved.

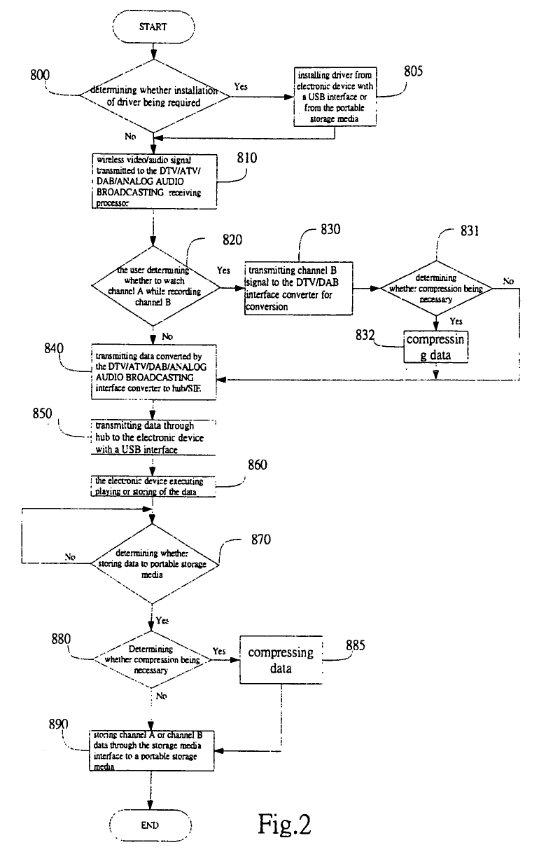

The operations of the DTV signal processor 22, the DAB signal processor 23, and the ATV signal processor 24 of the DTV/ATV/DAB/ANALOG AUDIO BROADCASTING interface converter 20 converting and transmitting data for playing or storing is not restricted to a single channel. The operations can be applied to multiple channels playing or storing simultaneously, and is explained by the following flowchart in FIG. 2.

FIG. 2 shows a flowchart of the operation of the DTV/ATV/DAB/ANALOG AUDIO BROADCASTING media storage apparatus 100 of the present invention. The flowchart shows the on-the-fly recording of the program, and the direct compression and storing. The method comprises the steps of:

(800) determining whether installation of driver being required; if so, proceeding to step (805); otherwise, proceeding to step (810);

(805) installing driver from electronic device with a USB interface or from the portable storage media;

(810) wireless video/audio signal transmitted to the DTV/ATV/DAB/ANALOG AUDIO BROADCASTING receiving processor, and converted into digital signals to transmit to the DTV/ATV/DAB/ANALOG AUDIO BROADCASTING interface converter;

(820) the user determining whether to watch channel A while recording channel B; if so, proceeding to step (830); otherwise, proceeding to step (840);

(830) transmitting channel B signal to the DTV/DAB interface converter for conversion;

(831) determining whether compression being necessary; if so, proceeding to step (832); otherwise, proceeding to step (840);

(832) compressing data;

(840) transmitting data converted by the DTV/ATV/DAB/ANALOG AUDIO BROADCASTING interface converter to hub/SIE; if not on-the-fly recording, transmitting only channel A signal to the DTV/DAB interface converter for conversion, and then to hub; otherwise, transmitting both channel A signal and channel B signal to the DTV/DAB interface converter for conversion, and then to hub;

(850) transmitting data through hub to the electronic device with a USB interface;

(860) the electronic device executing playing or storing of the data; if not on-the-fly recording, transmitting channel A data to the electronic device for playing; otherwise, transmitting channel A data to the electronic device for playing and transmitting channel B data to electronic device for storing;

(870) determining whether storing data to portable storage media; if so, proceeding to step (880); otherwise, repeating step (860);

(880) determining whether compression being necessary; if so, proceeding to step (885); otherwise, proceeding to step (890);

(885) compressing data; and

(890) storing channel A or channel B data through the storage media interface to a portable storage media; if not on-the-fly recording, storing only channel A data to the portable storage media, such as, flash memory, memory card, CD-RW, DVD-RW, or hard disk; otherwise, transmitting channel A data to the electronic device for playing and storing channel B data to portable storage media, such as, flash memory, memory card, CD-RW, DVD-RW, or hard disk.

The aforementioned steps (800)-(890) can be application software pre-stored in a computer. The method for controlling DTV/DAB on-the-fly recording or storing data directly to portable storage media is not limited to the aforementioned steps (800)-(890), and can be varied to use with other application software. In addition, the on-the-fly recording can be applied to multiple channels.

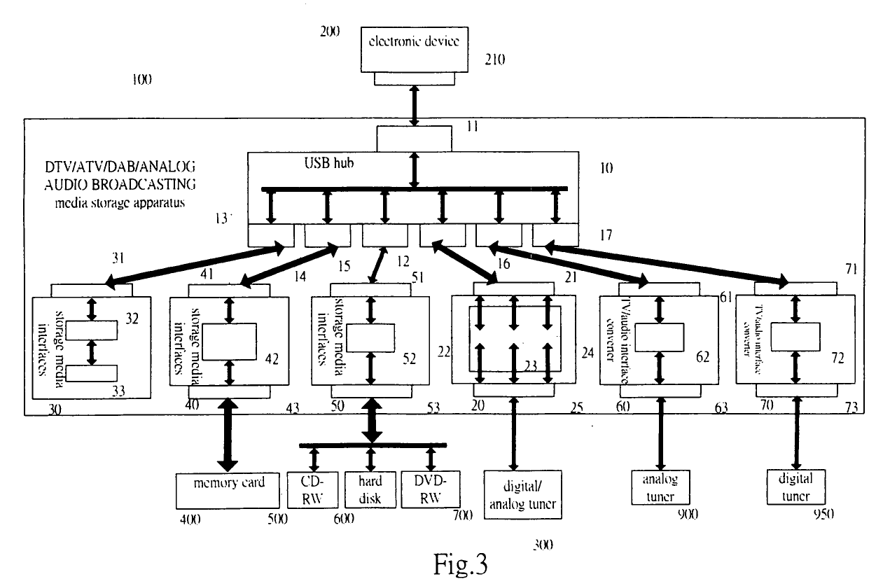

FIG. 3 shows the second embodiment of the present invention. A DTV/ATV/DAB/ANALOG AUDIO BROADCASTING media storage apparatus 100 is used in DTV/DAB/ATV application, including a TV/audio interface converter 60 and a TV/audio interface converter 70. The TV/audio interface converter 60 comprises a USB controller 61, an ATV signal processor 62, and a signal input interface 63. The USB controller 61 is connected to a downstream port 16 of the hub 10 so that the TV/audio interface converter 60 forms a two-way data communication with the hub 10. The ATV signal processor 62 performs signal conversion to convert ATV signal into a format suitable for playing on the electronic device 200. The ATV signal processor 62 is connected to the USB controller 61, which is connected to the hub 10. The upstream port 11 of the hub 10 will transmit converted data to the electronic device 200 for playing or storing. The signal input interface 63 is externally connected to an analog tuner 900. The analog tuner 900 receives ATV signal. The signal input interface 63 multiplexes the analog TV channels. The signal input interface 62 is internally connected to the ATV signal processor 62 to transmit signal to the ATV signal processor 62 for conversion.

The TV/audio interface converter 70 comprises a USB controller 71, a DTV signal processor 72, and a signal input interface 73. The USB controller 71 is connected to a downstream port 17 of the hub 10 so that the TV/audio interface converter 70 forms a two-way data communication with the hub 10. The DTV signal processor 72 performs signal conversion to convert DTV signal into a format suitable for playing on the electronic device 200. The DTV signal processor 72 is connected to the USB controller 71, which is connected to the hub 10. The upstream port 11 of the hub 10 transmits the converted data to the electronic device 200 for playing or storing. The signal input interface 73 is externally connected to a digital tuner 950. The digital tuner 950 receives the DTV signal. The signal input interface 73 multiplexes the digital TV channels. The signal input interface 73 is internally connected to the DTV signal processor 72 to transmit signal to the DTV signal processor 72 for conversion.

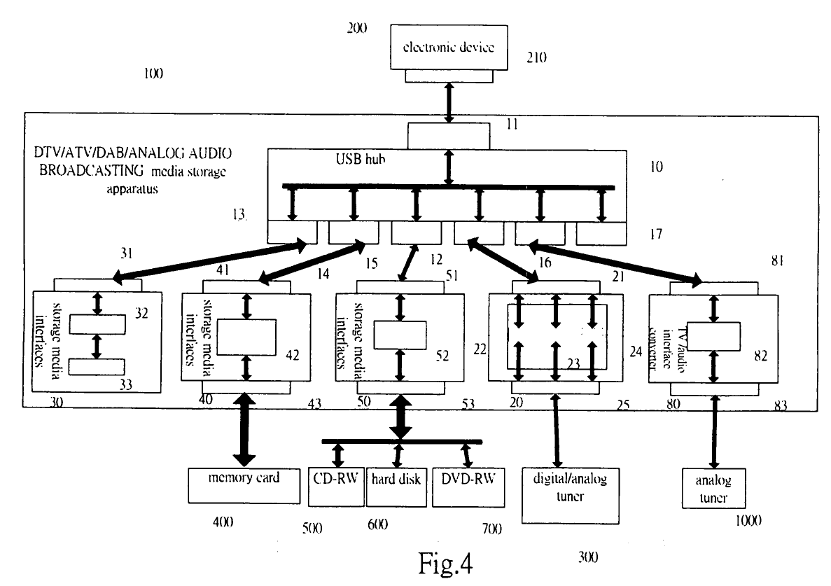

FIG. 4 shows a third embodiment of the present invention. A DTV/ATV/DAB/ANALOG AUDIO BROADCASTING media storage apparatus 100 is used in DTV/DAB/ANALOG AUDIO BROADCASTING application, including a TV/audio interface converter 80. The TV/audio interface converter 80 comprises a USB controller 81, an ANALOG AUDIO BROADCASTING signal processor 82, and a signal input interface 83. The USB controller 81 is connected to a downstream port 16 of the hub 10 so that the TV/audio interface converter 80 forms a two-way data communication with the hub 10. The ANALOG AUDIO BROADCASTING signal processor 82 performs signal conversion to convert the ANALOG AUDIO BROADCASTING signal into a format suitable for playing on the electronic device 200. The ANALOG AUDIO BROADCASTING signal processor 82 is connected to the USB controller 81, which is connected to the hub 10. The upstream port 11 of the hub 10 transmits the converted data to the electronic device 200 for playing or storing through the storage media interface 30, 40, 50 to portable storage media, such as the flash memory 33, the memory card 400, CD-RW, DVD-RW and the hard disk 600.

The signal input interface 83 is externally connected to an analog tuner 1000. The analog tuner 1000 receives the ANALOG AUDIO BROADCASTING signal, such as AM or FM. The signal input interface 83 multiplexes the analog audio broadcasting channels. The signal input interface 83 is internally connected to the ANALOG AUDIO BROADCASTING signal processor 22 to transmit signal to the ANALOG AUDIO BROADCASTING signal processor 82 for conversion.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A storage apparatus for digital TV video/analog TV video/digital audio broadcasting/analog audio broadcasting media, comprising:
at least a USB hub, having an upstream port and a plurality of downstream ports, the upstream being connected to a USB interface port of an electronic device;
a TV/audio interface converter, connected to a downstream port of the hub, connected to a digital/analog tuner to receive DTV/ATV/DAB/ANALOG AUDIO BROADCASTING signals, the DTV/ATV/DAB/ANALOG AUDIO BROADCASTING signal being converted by the TV/audio interface converter, and transmitted to the electronic device for playing; and
a plurality of storage media interfaces, connected respectively to the downstream ports, the storage media interfaces being portable media storage interface for connecting to portable storage media, respectively, for storing the DTV/ATV/DAB/ANALOG AUDIO BROADCASTING data transmitted from the electronic device through the hub.

2. The apparatus as claimed in claim 1, wherein the DTV/DAB interface converter further comprises:
a USB controller, connected to the downstream of the hub;
a DTV signal processor, connected to the USB controller to provide DTV signal conversion;
a DAB signal processor, connected to the USB controller to provide DAB signal conversion;
an ATV signal processor, connected to the USB controller to provide ATV signal conversion; and
a signal input interface, connected to the DTV signal processor, the DAB signal processor, the DAB signal processor, the ANALOG AUDIO BROADCASTING signal processor and a DTV/ATV/DAB/ANALOG AUDIO BROADCASTING receiving processor for transmitting DTV/ATV/DAB/ANALOG AUDIO BROADCASTING signal received by the DTV/ATV/DAB/ANALOG AUDIO BROADCASTING receiving processor to the DTV signal processor, the DAB signal processor, the DAB signal processor, and the ANALOG AUDIO BROADCASTING signal processor.

3. The apparatus as claimed in claim 1, wherein the storage media interface comprises a portable flash memory storage media interface.

4. The apparatus as claimed in claim 1, wherein the storage media interface further comprises:
a USB controller, connected to a downstream port of the hub;
a flash memory access controller, connected to the USB controller for providing data access to the portable flash memory storage media; and
a flash memory, connected to and controlled by the flash memory access controller.

5. The apparatus as claimed in claim 1, wherein the storage media interface comprises a portable card reader storage media interface.

6. The apparatus as claimed in claim 1, wherein the storage media interface further comprises:
a USB controller, connected to a downstream port of the hub;
a card reader access controller, connected to the USB controller for providing data access to portable card reader storage media; and
a memory connector, connected to a memory card and the card reader controller for enabling the memory card being controlled by the card reader access controller.

7. The apparatus as claimed in claim 1, wherein the storage media interface comprises a portable ATA/ATAPI-interfaced storage media interface.

8. The apparatus as claimed in claim 1, wherein the storage media interface further comprises:
a USB controller, connected to a downstream port of the hub;
an ATA/ATAPI interface controller, connected to the USB controller for providing data access to portable ATA/ATAPI-interfaced storage media; and
a plurality of interface connectors, connected to the ATA/ATAPI interface controller and a plurality of ATA/ATAPI-interfaced storage media for enabling the ATA/ATAPI-interfaced storage media being controlled by the ATA/ATAPI interface controller.

9. The apparatus as claimed in claim 8, wherein the ATA/ATAPI-interfaced storage media is a CD-RW, a DVD-RW or a hard disk.

10. The apparatus as claimed in claim 1, wherein the TV/audio interface converter further comprises:
a USB controller, connected to the downstream port of the hub;
an ATV signal processor, connected to the USB controller for performing ATV signal conversion; and
a signal input interface, connected to an analog tuner and the ATV signal processor for transmitting signal received by the analog tuner to the ATV signal processor.

11. The apparatus as claimed in claim 1, wherein the TV/audio interface converter further comprises:
a USB controller, connected to the downstream port of the hub;
an ANALOG AUDIO BROADCASTING signal processor, connected to the USB controller for performing ANALOG AUDIO BROADCASTING signal conversion; and
a signal input interface, connected to an analog tuner and the ANALOG AUDIO BROADCASTING signal processor for transmitting signal received by the analog tuner to the ANALOG AUDIO BROADCASTING signal processor.

12. The apparatus as claimed in claim 1, wherein the TV/audio interface converter further comprises:
a USB controller, connected to the downstream port of the hub;
a DTV signal processor, connected to the USB controller for performing DTV signal conversion; and
a signal input interface, connected to a digital tuner and the DTV signal processor for transmitting signal received by the digital tuner to the DTV signal processor.
